(19) United States
(12) Patent Application Publication
(10) Pub. No.: US 2007/0172664 A1
(43) Pub. Date: Jul. 26, 2007

(54) Cover and method for manufacturing the same

(75) Inventors: Jeng-Chi Peng, Tu-cheng (TW); Wan-Te Huang, Tu-cheng (TW); Si-Yi Wu, Shenzhen (CN); Guo-Dong Wu, Shenzhen (CN); Jian-Hua Li, Shenzhen (CN); Hong Yang, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/520,072

(22) Filed: Sep. 13, 2006

(30) Foreign Application Priority Data
Jan. 21, 2006 (CN) 200610033246.4

(51) Int. Cl. B32B 9/04; B32B 27/36; B32B 9/02

(52) U.S. Cl. 428/411.1; 428/412; 428/473

(57) ABSTRACT

The present invention discloses a cover including a protecting layer, a decorative layer and a bottom layer. The decorative layer has a first surface, and a second surface on the opposite side of the first surface. The protecting layer integrally is formed on the first surface of the decorative layer by injection molding. The bottom layer integrally is formed on the second surface of the decorative layer by injection molding. The present invention also provides a method for manufacturing a cover. The present cover can tend give a various appearances whilst also having good performance.

### CROSS-REFERENCE TO RELATED APPLICATIONS

This application is related to a co-pending U.S. patent applications, entitled “COVER AND METHOD FOR MANUFACTURING THE SAME”, by Jeng-Chi Peng et al. with Attorney Docket No. 14963-56682. Such application has the same assignee as the present application and has been concurrently filed herewith. The disclosure of the above identified application is incorporated herein by reference.

### 1. TECHNICAL FIELD

The present invention relates generally to covers, and more particularly to a cover with multiple layers having an improved performance and appearance. The present invention also relates to a method for manufacturing the cover.

### 2. BACKGROUND

Covers are widely used for the purpose of protecting gadgets, such as notebook computers, personal digital assistants, mobile phones, car instruments, and so on. To make these gadgets more physical appealing, the covers are decorated to have good appearances. Covers having exhibiting different appearances are prepared by one of coating, double injection molding, and in-mold labeling methods.

Typically, a cover is manufactured by a method of coating a resin layer on a surface of a colored sheet or film. However, the resin layer of such cover is prone to be broken off from the colored sheet or film, thus the appearance of cover is influenced. The method of double injection molding is carried out by injecting two kinds of materials separately into a mold, thereby forming a cover having patterns thereon. However, the patterns of such cover are simple. The in-mold labeling method typically includes the following steps of: adhering a film having patterns on an inner wall of a mold, and a surface having patterns of the film being in contact with the inner wall of the mold; introducing a molten thermoplastic resin into the mold to form a resin layer on the film; cooling the resin layer to combine with the film to form a cover. However, the surface with patterns of such cover is exposed on the exterior, as a result, the patterns are prone to be scratched, thus appearance of cover is influenced in use.

Therefore, what is needed is to provide a cover that can tend give various appearances whilst also having good performance, and a method for manufacturing the same.

### SUMMARY

A cover according to a preferred embodiment includes a decorative layer, a protecting layer and a bottom layer. The decorative layer has a first surface, and a second surface on the opposite side of the first surface. The protecting layer integrally is formed on the first surface of the decorative layer by injection molding. The bottom layer integrally is formed on the second surface of the decorative layer by injection molding.

A method for manufacturing a cover according to another preferred embodiment includes the following steps: providing a decorative base; trimming the decorative base thereby forming a decorative layer; forming a first layer on a surface of the decorative layer by injection molding; forming a second layer on another surface of the decorative layer by injection molding.

Other advantages and novel features will become more apparent from the following detailed description of the preferred embodiments, when taken in conjunction with the accompanying drawings.

### BRIEF DESCRIPTION OF THE DRAWINGS

Many aspects of the present cover and method for manufacturing the same can be better understood with reference to the following drawings. The components in the drawings are not necessarily drawn to scale, the emphasis instead being placed upon clearly illustrating the principles of the cover and method for manufacturing the same. Moreover, in the drawings, like reference numerals designate corresponding parts throughout the several views.

FIG. 1 is a schematic, cross-sectional view of a cover according to a preferred embodiment;

FIG. 2 a flow chart of a method for manufacturing the cover of FIG. 1;

FIG. 3 is a schematic, cross-sectional view of an apparatus in the period of forming a protecting layer on a first surface of a decorative layer for manufacturing the cover of FIG. 1;

FIG. 4 is a schematic, cross-sectional view of an apparatus in the period of forming a bottom layer on a second surface of the decorative layer for manufacturing the cover of FIG. 1;

FIG. 5 is a schematic, cross-sectional view of an apparatus in the period of forming a bottom layer before forming a protecting layer for manufacturing the cover of FIG. 1; and

FIG. 6 is a schematic, cross-sectional view of an apparatus in the period of forming a protecting layer after forming a bottom layer for manufacturing the cover of FIG. 1.

### DETAILED DESCRIPTION OF THE PREFERRED EMBODIMENTS

Reference will now be made to the drawings to describe preferred embodiments of the present cover and method for manufacturing the same, in detail.

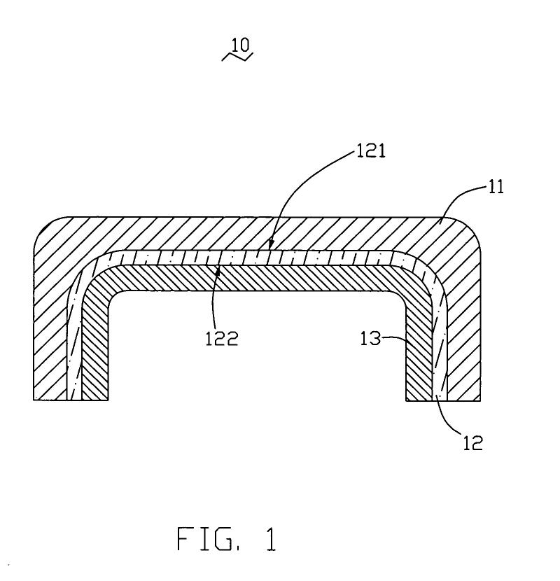

Referring to FIG. 1, a cover 10 according to a preferred embodiment is shown. The cover 10 includes a protecting layer 11, a decorative layer 12, and a bottom layer 13. The decorative layer 12 includes a decorative first surface 121 having predetermined patterns or colors, and a second surface 122 on the opposite side of the first surface. The protecting layer 11 and the bottom layer 13 are integrally formed on the first surface 121 and the second surface 122 respectively by injection molding.

The decorative layer 12 is used for providing the predetermined patterns or colors on the first surface 121. The decorative layer 12 is a sheet or a film. The sheet has better structure strength, and can be thicker than the film. For example, the sheet has a thickness in a range from about 0.25 millimeters to about 0.7 millimeters; the film has a thickness in a range from about 0.05 millimeters to about 0.5 millimeters. A material of the decorative layer 12 is selected from a group consisting of plastic, leather, and fabric. Since the decorative layer 12 can be firstly produced independently from the protecting layer 11 and bottom layer 13, the decorative layer 12 may be prepared to have predetermined colors or patterns; as such the cover can exhibit complex appearances easily.

In use, the protecting layer 11 is exposed on the exterior, thus the protecting layer 11 is configured to be translucent, semi-transparent or transparent for visualization of the patterns or colors of the decorative layer 12. A material of the protecting layer is selected from a group consisting of polycarbonate, acrylonitrile-butadiene-styrene terpolymer, and polymethyl methacrylate.

The bottom layer 13 mainly employs plastic. The plastic is selected from a group consisting of polycarbonate, acrylonitrile-butadiene-styrene terpolymer, and polymethyl methacrylate, polyvinyl chloride, polyethylene, polystyrene, and any combination thereof.

The protecting layer 11 and bottom layer 13 cooperatively protect the decorative layer 12. Therefore, the cover 10 has a relatively long operational life because the decorative layer 12 is prevented from being distorted or scratched.

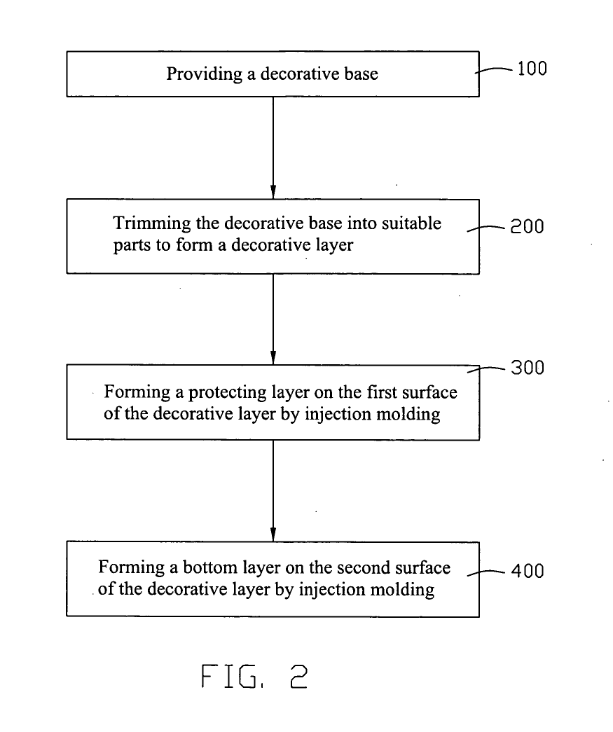

Referring to FIG. 2, a flow chart of a method for manufacturing the cover 10 is shown. The method includes following steps of:

step 100: providing a decorative base;

step 200: trimming the decorative base into suitable parts to form a decorative layer 12, the decorative layer 12 having a first surface 121 and a second surface 122 on the opposite side of the first surface 121;

step 300: forming a protecting layer 11 on the first surface 121 of the decorative layer 12 by injection molding; and

step 400: forming a bottom layer 13 on the second surface 122 of the decorative layer 12 by injection molding.

In step 100, the decorative base is a sheet or a film. For example, the sheet has a thickness in a range from about 0.25 millimeters to about 0.7 millimeters. The film has a thickness in a range from about 0.05 millimeters to about 0.5 millimeters. The decorative base has patterns or colors thereon. The patterns or colors can be formed by plating or printing.

Before trimming the decorative base into the suitable parts, the decorative base needs to be pressed by hot press molding into a predetermined shape.

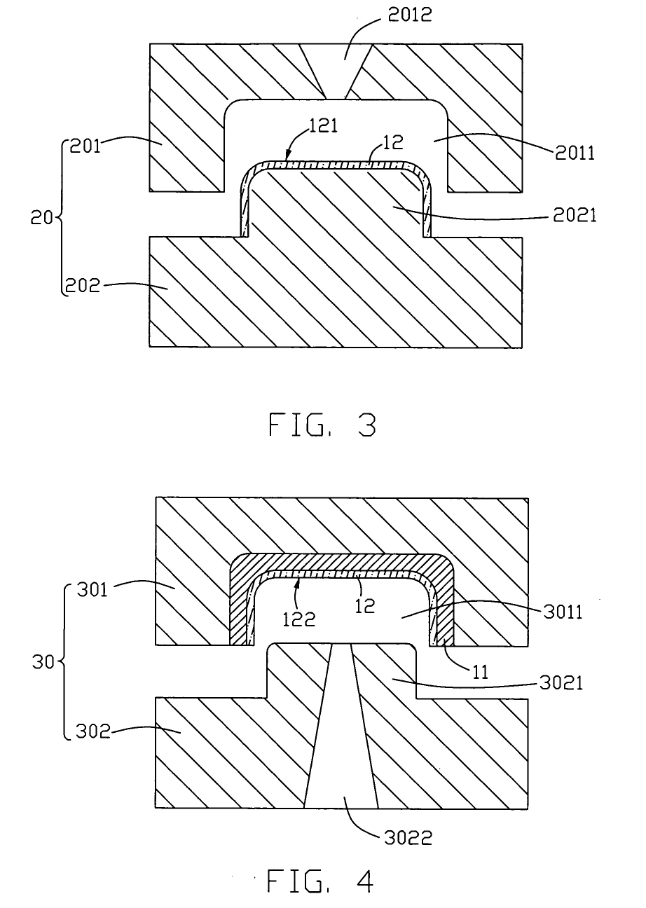

In step 300, forming the protecting layer 11 on the first surface 121 includes following steps of: referring to FIGS. 3 and 4, providing a mold 20 that includes an upper molding portion 201 and a lower molding portion 202, the lower molding portion 202 has a molding block 2021, the upper molding portion 201 defines a molding cavity 2011 that substantially conforms to the molding block 2021, and further defines a guiding channel 2012 in the upper molding portion 201 above the molding cavity 2011 communicating with the molding cavity 2011; setting the decorative layer 12 on the molding block 2021; fastening the upper molding portion 201 and the lower molding portion 202 together; introducing a resin from the guiding channel 2012 onto the first surface 121, thereby forming the protecting layer 11. The resin is selected from a group consisting of polycarbonate, acrylonitrile-butadiene-styrene terpolymer, and polymethyl methacrylate.

In step 400, forming the bottom layer 13 on the second surface 122 includes following steps of: providing a mold 30 that includes an upper molding portion 301 and a lower molding portion 302, the lower molding portion 302 has a molding block 3021 and further defines a guiding channel 3022 in the molding block 3021, the upper molding portion 301 defines a molding cavity 3011 that substantially conforms to the molding block 3021; setting the decorative layer 12 on the molding cavity 3011; fastening the upper molding portion 301 and the lower molding portion 302 together; introducing a second resin from the guiding channel 3022 onto the second surface 122, thereby forming the bottom layer 13. The second resin is selected from a group consisting of polycarbonate, acrylonitrile-butadiene-styrene terpolymer, and polymethyl methacrylate, polyvinyl chloride, polyethylene, polystyrene, and any combination thereof.

In use, because the protecting layer 11 and the bottom layer 13 are affixed to the decorative layer 11 with the injection molding method, adhesions between the protecting layer 11 and the decorative layer 12, and between the bottom 13 and the decorative layer 12 are improved.

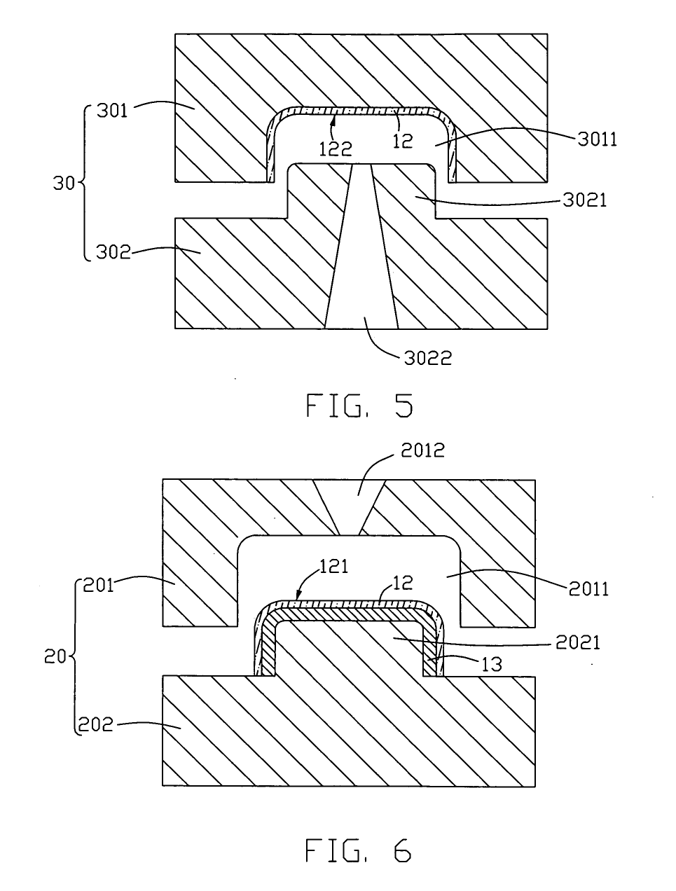

Alternatively, referring to the FIGS. 5 and 6, according to an aspect of the embodiment, the order of step 300 and step 400 can be exchanged. Also, according to another aspect of the embodiment, using a different mold, the step 300 and step 400 can be carried out simultaneously.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. A cover comprising:
a decorative layer having a first surface, and a second surface on the opposite side of the first surface;
a protecting layer integrally formed on the first surface of the decorative layer by injection molding; and
a bottom layer integrally formed on the second surface of the decorative layer by injection molding.

2. The cover as described in claim 1, wherein the decorative layer is one of a sheet and a film.

3. The cover as described in claim 2, wherein a material of decorative layer is selected from a group consisting of plastic, leather, and fabric.

4. The cover as described in claim 2, wherein the thickness of sheet is in a range from about 0.25 millimeters to about 0.7 millimeters.

5. The cover as described in claim 2, wherein the thickness of film is in a range from about 0.05 millimeters to about 0.5 millimeters.

6. The cover as described in claim 1, wherein the decorative layer further comprises patterns or colors on the first surface.

7. The cover as described in claim 1, wherein the protecting layer is one of a semi-transparent and transparent layer.

8. The cover as described in claim 1, wherein a material of the protecting layer is selected from a group consisting of polycarbonate, acrylonitrile-butadiene-styrene terpolymer, and polymethyl methacrylate.

9. The cover as described in claim 1, wherein a material of the bottom layer is plastic.

10. The cover as described in claim 9, wherein the plastic is selected from a group consisting of polycarbonate, acrylonitrile-butadiene-styrene terpolymer, and polymethyl methacrylate, polyvinyl chloride, polyethylene, polystyrene, and any combination thereof.

11. A method for manufacturing a cover, comprising the steps of:
providing a decorative base;
trimming the decorative base thereby forming a decorative layer;
forming a first layer on a first surface of the decorative layer by injection molding; and
forming a second layer on a second surface of the decorative layer by injection molding.

12. The method as described in claim 11, wherein the decorative base has patterns or colors thereon.

13. The method as described in claim 11, wherein the patterns or colors are formed on the decorative base by one of plating and printing.

14. The method as described in claim 11, further comprises a step of hot press molding the decorative base, before the step of trimming the decorative base.

15. The method as described in claim 11, wherein the step of forming the first layer is performed using a mold that comprises an upper molding portion and a lower molding portion; the lower molding portion has a molding block; the upper molding portion defines a molding cavity engaged with the molding block, and a guiding channel defined in the upper molding portion above the molding cavity and communicating with the molding cavity.

16. The method as described in claim 11, wherein the step of forming the second layer is performed using a mold that comprises an upper molding portion and a lower molding portion; the lower molding portion has a molding block and defines a guiding channel in the molding block; the upper molding portion defines a molding cavity engaged with the molding block.

17. The method as described in claim 11, wherein the step of forming the first layer and the step of forming the second layer are carried out simultaneously.

18. A method for making a cover, the method comprising the steps of:
preparing a decorative layer having a decorative surface on one side of the decorative layer, and another surface on an opposite side of the decorative layer;
forming a first protective layer on the decorative surface of the decorative layer by injection molding; and
forming a second protective layer on the another surface of the decorative layer by injection molding.
